(19) United States
(12) Patent Application Publication
(10) Pub. No.: US 2021/0257600 A1
(43) Pub. Date: Aug. 19, 2021

(54) CONNECTION MODULE FOR PROTECTING BATTERY CELLS

(71) Applicant: STL Technology Co., Ltd., Kaohsiung City (TW)

(72) Inventors: Cooper Chang, Kaohsiung City (TW); Ching-Po Lin, Kaohsiung City (TW)

(21) Appl. No.: 16/920,658

(22) Filed: Jul. 4, 2020

(30) Foreign Application Priority Data
Feb. 17, 2020 (CN) 202020177391.5

(51) Int. Cl. H01M 2/34; H01M 2/10; H01M 2/20; H01M 10/04; H01M 10/643

(52) U.S. Cl. CPC H01M 2/348; H01M 2/1016; H01M 2200/10; H01M 10/0422; H01M 10/643; H01M 2/202

(57) ABSTRACT

A connection module for protecting battery cells includes a plurality of conductive sheets, a plurality of conductive wires, or a conductive mesh. The conductive sheets are connected with at least one battery cell. The conductive wires or the conductive mesh is connected to the conductive sheets. An electrical conductivity of the conductive wires or the conductive mesh is higher than that of the conductive sheets. When the battery cells connected to the conductive sheets damages, it may cause an electrolyte ejected from the battery cells, or a large current passing through the conductive wires or the conductive mesh, such that the conductive wires or the conductive mesh is burned and melted to achieve the purpose of protecting other battery cells.

This non-provisional application claims priority claim under 35 U.S.C. § 119 (a) on China Patent Application No. 202020177391.5 filed Feb. 17, 2020, the entire contents of which are incorporated herein by reference.

### FIELD OF THE INVENTION

The present invention relates to a connection module, more particularly, a connection module capable of protecting battery cells.

### BACKGROUND

Rechargeable batteries are widely used in many products, such as notebook computer, tablet computer, mobile communication device, electric bicycle, electric motorcycle, or electric vehicle. Generally, a plurality of battery cells are connected together in series or/and parallel to form a battery pack. The battery pack can provide the voltage required by the product.

The structure of the battery cell includes a positive electrode material, an electrolyte, a negative electrode material, a separator film, and a shell. The separator film is for separating the positive electrode material and negative electrode material to avoid that the battery cell happens a short circuit. The electrolyte is configured in pores of the separator film, and used for conducting an ionic charge. The shell is used to cover the positive electrode material, the separator film, the electrolyte, and the negative electrode material. The shell is usually made of metal material.

If one of battery cells in the battery pack damages to form a short circuit, the other normal battery cells charge the short-circuited battery cell in large current, and therefore the temperature of the short-circuited battery cell rises abnormally. When the temperature of the short-circuited battery cell has exceeded the temperature that the separator film inside the battery cell can withstand, the separator film will be dissolved to form the short circuit on the positive electrode material and the negative electrode material of the battery cell, and therefore cause a burning or an exploding of the battery cell.

Besides, the electrolyte may be ejected or leaked from the damaged battery cell, and transferred to other normal battery cells or conductive sheets in a gas form or a liquid form. Afterwards, the temperatures of the conductive sheets and the battery cells connected with the conductive sheets will be abnormally raised due to the ejection or leakage electrolyte, and therefore other normal battery cells will be damaged.

### SUMMARY

It is one objective of the present invention to provide a connection module capable of protecting battery cells, which comprises a plurality of conductive sheets, a plurality of conductive wires, or a conductive mesh. The conductive sheets are connected with at least one battery cell. The conductive wires or the conductive mesh is connected with the conductive sheets. When an electrolyte is ejected from the damaged battery cell, the conductive wires or the conductive mesh will be burned and melted, in such a way that an explosion of the normal battery cell can be avoided.

It is one objective of the present invention to provide a connection module capable of protecting battery cells, which comprises a plate body, at least two connection portions, and a perforation portion. The connection portions are connected with at least one battery cell, and the perforation portion is disposed between the two connection portions. By the disposition of the perforation portion, it can avoid the exploding of the damaged battery cell to prevent that the other normal battery cells can be affected by the exploding of the damaged battery cell.

To achieve the above objective, the present invention provides a connection module for protecting battery cells, comprising: a plurality of conductive sheets, wherein each of the plurality of conductive sheets is connected to a corresponding battery cell, respectively; and a plurality of conductive wires or a conductive mesh, wherein the plurality of conductive wires or the conductive mesh is connected to the plurality of conductive sheets such that the battery cells connected with the plurality of conductive sheets are connected together via the plurality of conductive wires or the conductive mesh; wherein an electrical conductivity of the plurality of conductive wires or the conductive mesh are higher than that of the plurality of conductive sheets.

The present invention further provides a connection module for protecting battery cells, comprising: a plurality of conductive connection sheets, wherein each of the plurality of conductive connection sheets is connected with two battery cells in serial, respectively; and a plurality of conductive wires or a conductive mesh, wherein the plurality of conductive wires or the conductive mesh is connected with two of the plurality of conductive sheets such that the battery cells connected with the plurality of conductive sheets are connected together via the plurality of conductive wires or the conductive mesh in parallel; wherein an electrical conductivity of the plurality of conductive wires or the conductive mesh is higher than that of the plurality of conductive connection sheets.

The present invention further provides a connection module for protecting battery cells, comprising: a plate body; two connection portions, configured at two ends of the plate body, and connected with a battery cell, respectively; and a perforation portion, wherein the perforation portion is connected between the two connection portions such that the battery cells connected with the two connection portions are connected together via the perforation portion; wherein the perforation portion comprises a plurality of strip-shaped perforations.

The present invention further provides a connection module for protecting battery cells, comprising: a plurality of conductive connection sheets, wherein each of the plurality of conductive connection sheets is connected with two battery cells in serial, respectively; and a perforation portion, wherein the perforation portion is connected to two of the plurality of conductive connection sheets such that the battery cells connected with the plurality of conductive connection sheets are connected together via the perforation portion; wherein the perforation portion comprises a plurality of strip-shaped perforations.

In one embodiment of the present invention, the connection module further comprises a eutectic portion disposed between the plurality of conductive sheets and the plurality of conductive wires, or disposed between the plurality of conductive sheets and the conductive mesh.

In one embodiment of the present invention, wherein the battery cells connected with the plurality of conductive sheets are connected together in serial or parallel via the conductive mesh.

In one embodiment of the present invention, wherein the conductive mesh comprises a plurality of first conductive wires arranged in a horizontal direction and a plurality of second conductive wires arranged in a vertical direction, the plurality of first conductive wires are connected to the plurality of conductive sheets, and the plurality of second conductive wires are connected to each of the plurality of first conductive wires.

In one embodiment of the present invention, wherein the perforation portion further comprises a plurality of strip-shaped conductive portions adjacent to the plurality of strip-shaped perforation.

### BRIEF DESCRIPTION OF THE DRAWINGS

FIG. 1 is a stereogram diagram of a connection module according to one embodiment of the present invention.

FIG. 2 is a stereogram diagram of a connection module according to one embodiment of the present invention.

FIG. 3 is a side view of a connection module according to another embodiment of the present invention.

FIG. 4 is a stereogram diagram of a connection module according to one embodiment of the present invention.

FIG. 5 is a side view of a connection module according to another embodiment of the present invention.

FIG. 6 is a side view of a connection module according to another embodiment of the present invention.

FIG. 7 is a side view of a connection module according to another embodiment of the present invention.

### DETAILED DESCRIPTION OF THE PREFERRED EMBODIMENTS

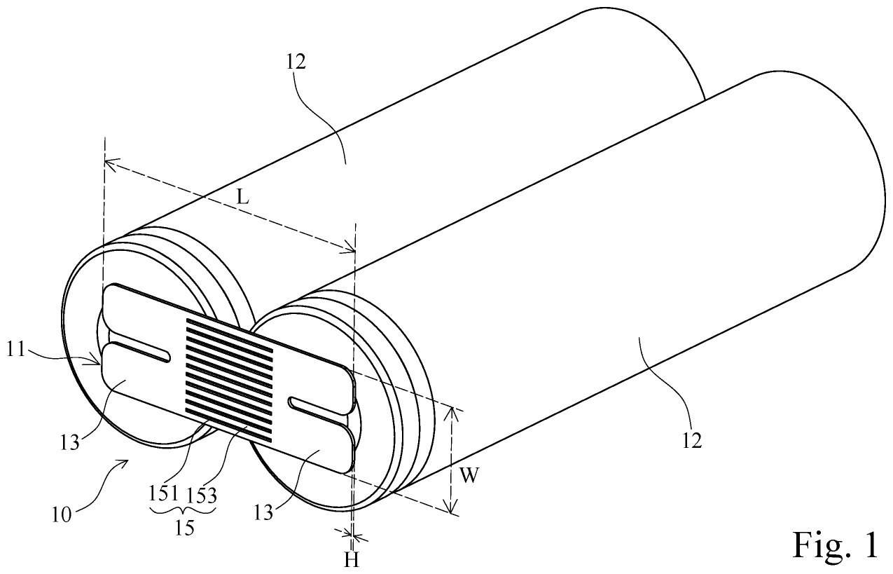

Referring to FIG. 1, there is shown a stereogram diagram of a connection module according to one embodiment of the present invention. As shown in FIG. 1, the connection module 10 of the present embodiment is connected with a plurality of battery cells 12, and comprises a plate body 11, at least two connection portions 13, and a perforation portion 15. The two connection portions 13 are configured at two ends of the plate body 11, respectively. The perforation portion 15 is disposed between the two connection portions 13, and connected to the two connection portions 13.

The connection module 10 is connected with two battery cells 12 in series or in parallel. Wherein the two connection portions 13 configured at two ends of the plate body 11 are connected with one battery cell 12, respectively such that the two battery cells 12 connected with the connection portions 13 are connected together via the perforation portion 15.

The perforation portion 15 comprises a plurality of strip-shaped perforations 151 and a plurality of strip-shaped conductive portions 153 adjacent to the strip-shaped perforations 151. For example, the plate body 11 is a metal sheet, and the strip-shaped perforations 151 and the strip-shaped conductive portions 153 can be formed on the plate body 11 by a way of stamping, etching, or casting. Specifically, a larger number of the strip-shaped perforations 151 can formed on the plate body 11 by the way etching; while the number of strip-shaped perforations 151 formed on the plate body 11 by the way stamping or casting is less.

The sectional area of the perforated portion 15 can be effectively reduced by the disposition of the strip-shaped perforations 151. For example, the sectional area of the perforation portion 15 will be smaller than that of the connection portion 13. In the embodiment of the present invention, the perforation portion 15 and the connection portions 13 can be made of the same material, and therefore a resistance value of the perforated portion 15 having the smaller sectional area will be greater than that of the connection portion 13. When a current of one of the battery cells 12 flows to the other battery cell 12 via the connection module 10, the temperature of the perforated portion 15 with a larger resistance value will be higher than that of the connection portion 13.

Specifically, when one of the battery cells 12 damages, the other normal battery cells 12 may charge the damaged battery cell 12 via the connection module 10, which makes that a current passing through the connection module 10 will be increased, and therefore the temperature of the perforation portion 15 will be risen. When a current passed through the perforation portion 15 is larger than a predetermined current, the perforation portion 15 will be melted and broken due to the rising of the temperature, and therefore a broken circuit is formed between the damaged battery cell 12 and the other normal battery cells 12. Accordingly, the other normal battery cells 12 will not execute a charge of the damaged battery cell 12.

These battery cells 12 are connected together via the connection module 10, which can prevent the normal battery cells 12 to continuous charge the short-circuit battery cell 12 in the large current, thereby reducing the probability of the melting or explosion of the battery cells 12, and improving the safety of the battery pack in use.

Besides, the high temperature electrolyte in the damaged battery cell 12 may ejected in a gas form or a liquid form, the liquid or gaseous electrolyte ejected will diffuse around, and contact the other battery cells 12 and the connection module 10 such that the temperatures of the other battery cells 12 and the connection module 10 rise abnormally.

Because the structure of the perforation portion 15 of the connection module 10 is relatively fragility, the perforation portion 15 will be burned and melted after contacting the high temperature electrolyte ejected from the damaged battery cell 12, and therefore the broken circuit is formed between the damaged battery cell 12 and the other normal battery cells 12. Accordingly, the situation that the other normal battery cells 12 execute the charging of the damaged battery cell 12 can be avoided to prevent the normal battery cells 12 to be affected by the damaged battery cell 12.

Specifically, when the sectional area of the perforation portion 15 of the connection module 10 is larger, the resistance value of the connection module 10 will be decreased to reduce the loss of the energy; when the sectional area of the perforation portion 15 of the connection module 10 is smaller, the perforation portion 15 will have a larger resistance value, so that as long as the small current passed the perforation portion 15 will be melted and broken.

Furthermore, the strip-shaped perforations 151 and the strip-shaped conductive portions 153 are formed on the plate body 11 by the way of etching, which can not only increase the number of the strip-shaped perforations 151 on the connection module 10, but the sectional area of the strip-shaped conductive portions 153 can be effectively reduced. Specifically, when the sectional area of each of the strip-shaped conductive portions 153 is smaller, the strip-shaped conductive portions 153 will be easily burned and melted to form the broken circuit after contacting the electrolyte ejected from the damaged battery cell 12, so that the connection module 10 has a better protection for the battery cells 12.

In one embodiment of the present invention, the connection module 10 is made of copper material. Wherein the length (L) of the connection module 10 is 20-30 mm, the width (W) of that is 10-15 mm, and the thickness (H) of that is 0.3 mm. The material, the length (L), the width (W) and the thickness (H) of the connection module 10 of the above description are only one embodiment of the present invention, which are not used for limiting the scopes of the claims of the present invention. Without significantly affecting the conductive effect and the energy consumption of the connection module 10, the material of the connection module 10 can be selected according to the requirement of actual application, and the length (L), the width (W) and the thickness (H) of the connection module 10 can be adjusted, so that the connection module 10 can effectively protect the battery cells 12.

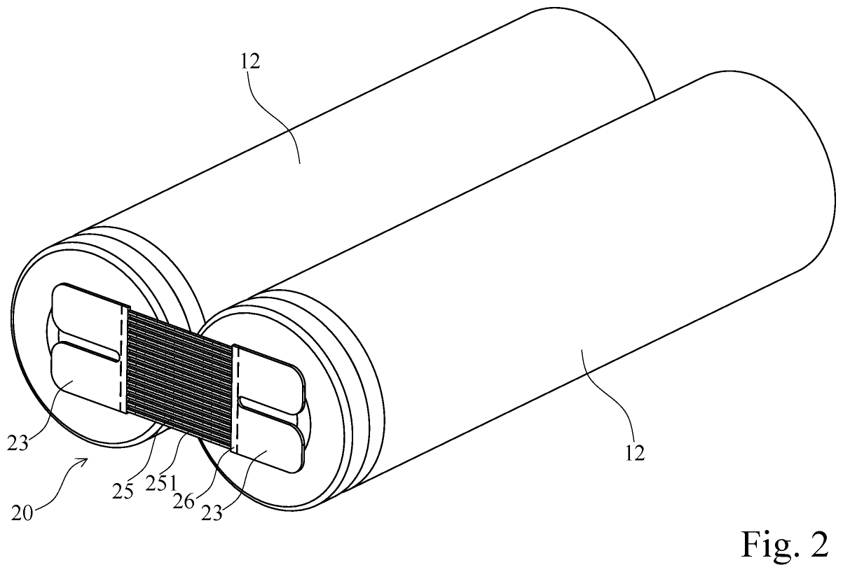

Referring to FIG. 2, there is shown a stereogram diagram of the connection module according to another embodiment of the present invention. As shown in FIG. 2, the connection module 20 of the present embodiment is connected with a plurality of battery cells 12, and comprises at least two conductive sheets 23 and a plurality of conductive wires 25. Each of the two conductive sheets 23 is connected with one corresponding battery cell 12, respectively, and the plurality of conductive wires 25 are connected between the two conductive sheets 23 such that the battery cells 12 connected with the conductive sheets 23 are connected together via the conductive wires 25. Wherein there is a gap 251 formed between the adjacent conductive wires 25.

Specifically, the conductive sheets 23 are metal conductive sheets, and the conductive wires 25 are metal conductive wires. The conductive wires 25 and the conductive sheets 23 can be connected together via an electric welding, and a eutectic portion 26 is formed between the conductive wires 25 and each of the conductive sheets 23. Wherein the eutectic portion 26 is located between the conductive wires 25 and each of the conductive sheets 23, and connected with the conductive wires 25 and the conductive sheets 23.

When a current passed through the conductive wires 25 is larger than a predetermined current, the conductive wires 25 will be melted and broken due to the rising of the temperature, and therefore a broken circuit is formed between the damaged battery cell 12 and the other normal battery cells 12 to achieve the purpose of protecting the battery cells 12.

Furthermore, the conductive wires 25 will be burned and melted after contacting the high temperature electrolyte ejected from the damaged battery cell 12, and therefore a broken circuit is formed between the damaged battery cell 12 and the other normal battery cells 12 so that the abnormal charging of the battery cells 12 can be avoided.

In one embodiment, the conductive wires 25 and the conductive sheets 23 can be made of different materials. Wherein the electrical conductivity of the materials of the conductive wires 25 may be higher than the electrical conductivity of the materials of the conductive sheets 23, for example, the conductive wires 25 may be copper wires, and the conductive sheets 23 is nickel sheets.

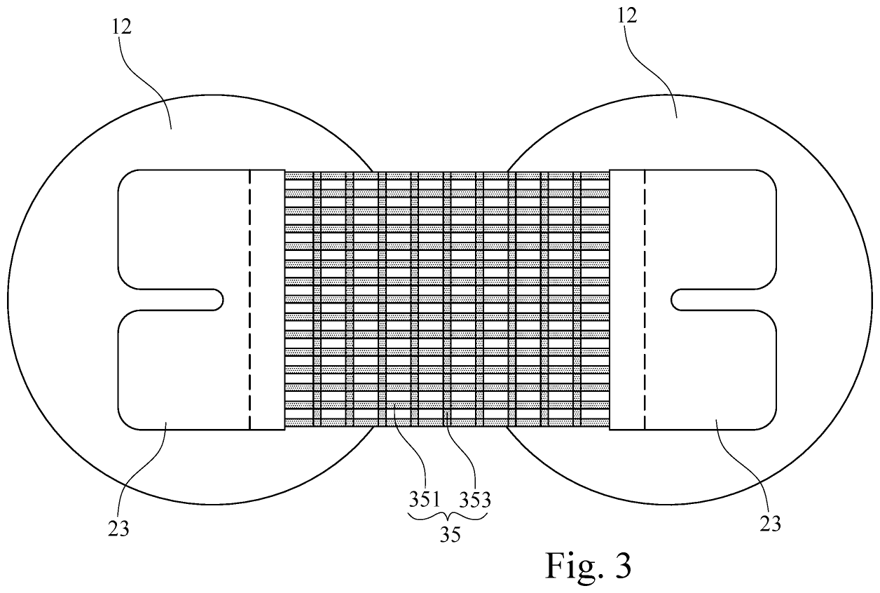

In one embodiment of the present invention, the plurality of conductive sheets 23 can be connected together via a conductive mesh 35, as shown in FIG. 3. The arrangement and the efficacy of the conductive mesh 35 are similar to those conductive wires 25. Accordingly, the conductive mesh 35 will be burned and melted when a current passed through the conductive mesh 35 is larger than the predetermined current, or the conductive mesh 35 contacts the high temperature electrolyte ejected from the damaged battery cell 12, in such a way the battery cells 12 connected to the connection module 30 can be protected.

Specifically, the conductive mesh 35 comprises a plurality of first conductive wires 351 arranged in a horizontal direction and a plurality of second conductive wires 353 arranged in a vertical direction. Wherein the plurality of first conductive wires 351 are connected with two conductive sheets 23, and the plurality of second conductive wires 353 are connected to each of the plurality of first conductive wires 351 to balance the potential of each of the first conductive wires 351.

As shown in FIG. 3, the first conductive wires 351 and the second conductive wires 353 are orthogonal. In the actual application, however, the first conductive wires 351 and the second conductive wires 353 may be not orthogonal. Thus, the present invention that the first conductive wires 351 and the second conductive wires 353 are orthogonal, which is only one embodiment of the present invention, and not used for limiting the scopes of the claims of the present invention.

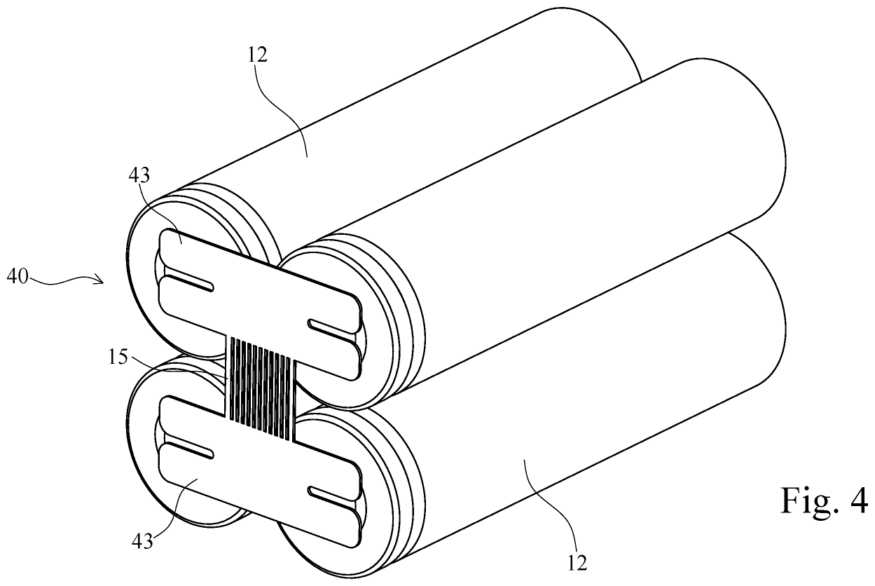

Referring to FIG. 4, there is shown a stereogram diagram of the connection module according to another embodiment of the present invention. As shown in FIG. 4, the connection module 40 of the present embodiment is connected with a plurality of battery cells 12, and comprises at least two conductive connection sheets 43 and a perforation portion 15. The two conductive connection sheets 43 are connected with the two battery cells 12 in serial, and the perforation portion 15 is connected with the two conductive connection sheets 43, such that the battery cells 12 connected with the conductive connection sheets 43 can be connected together via the perforation portion 15 in parallel.

When one of the battery cells 12 damages, the perforation portion 15 will be burned and melted because of contacting the high temperature electrolyte ejected from the damaged battery cell 12, and therefore a broken circuit is formed between the damaged battery cell 12 and the other normal battery cells 12 so that the abnormal charging of the battery cells 12 can be avoided.

When the normal battery cells 12 execute the abnormal charging for the damaged battery cell 12, the perforation portion 15 will be burned and melted by a large current passing through therein, such that the normal battery cells 12 will not charge the damaged battery cell 12 connected with the normal battery cells 12 in parallel, and therefore the explosion of the damaged battery cell 12 can be avoided.

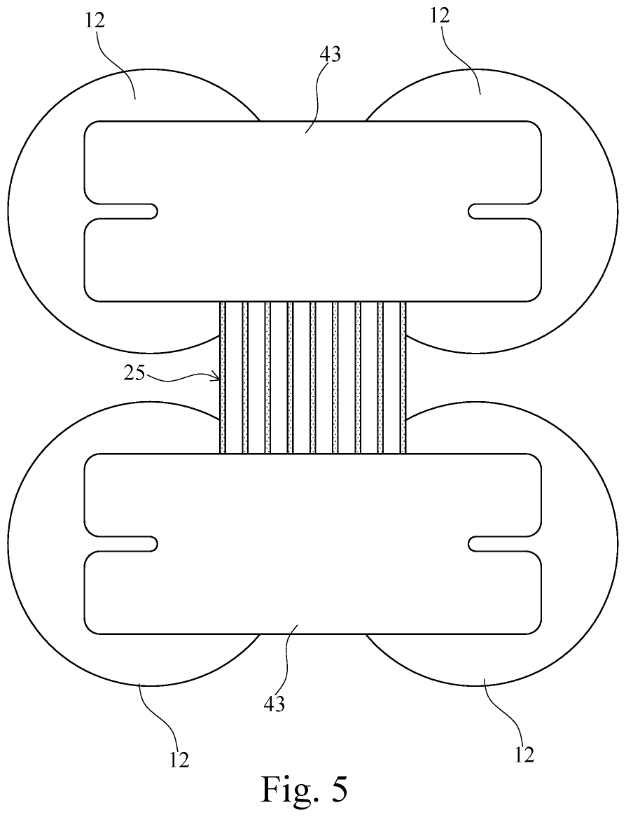

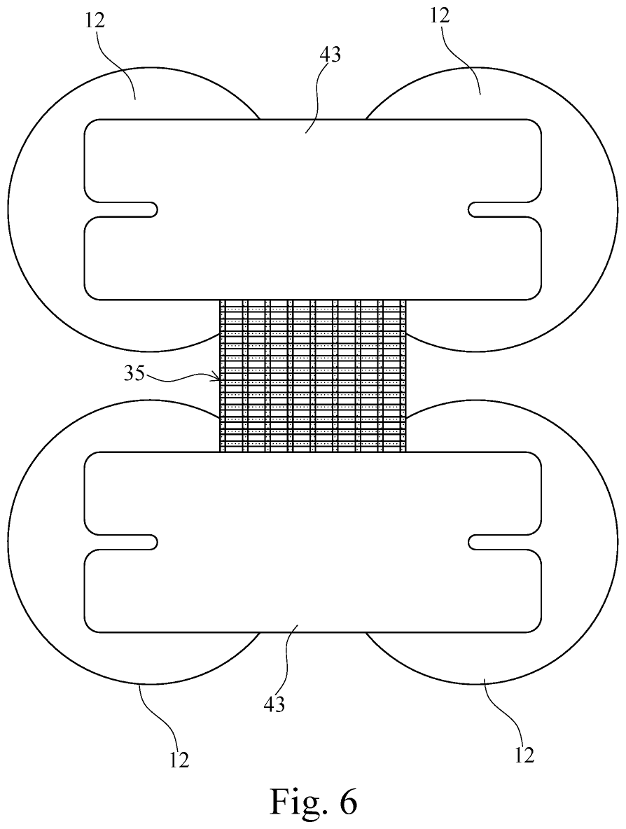

As shown in FIG. 5, in other embodiment of the present invention, the two conductive connection sheets 43 may be connected together via a plurality of conductive wires 25, such that the battery cells 12 connected with the two conductive connection sheets 43 are connected together in parallel via the plurality of conductive wires 25. As shown in FIG. 6, in another embodiment of the present invention, the two conductive connection sheets 43 may be connected together via a conductive mesh 35, such that the battery cells 12 connected with the two conductive connection sheets 43 are connected together in parallel via the conductive mesh 35. Besides, the electrical conductivity of the conductive wires 25 and the conductive mesh 35 are higher than that of the conductive connection sheets 43.

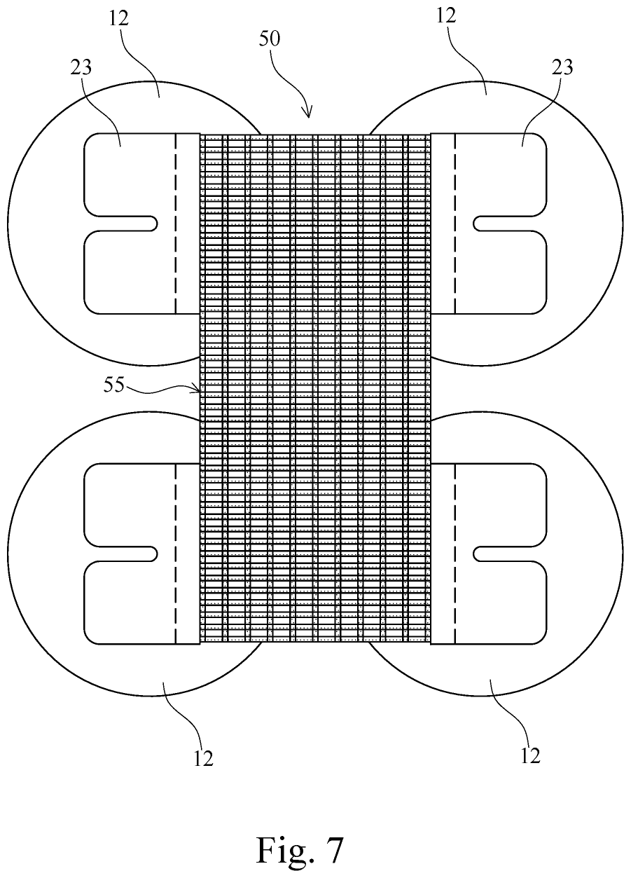

Referring to FIG. 7, there is shown a side view of the connection module according to another embodiment of the present invention. As shown in FIG. 7, the connection module 50 of the present embodiment is connected with the plurality of battery cells 12, and comprises a plurality of conductive sheets 23 and a conductive mesh 55. Wherein the conductive mesh 55 is connected to each of the conductive sheets 23.

Specifically, the number of the battery cells 12 and the conductive sheets 23 are the same, which may be four or more. Wherein each of the conductive sheets 23 is connected to each of the battery cells 12, respectively, and the conductive mesh 55 is connected to each of the conductive sheets 23, such that the battery cells 12 connected with the conductive sheets 23 are connected together in serial or in parallel via the conductive mesh 55.

The conductive mesh 55 is burned and melted because of contacting the high temperature electrolyte ejected from the damaged battery cell 12, or passing a large current, so as to achieve the purpose of protecting the battery cells 12. Besides, the conductive wires 55 and the conductive sheets 23 can be made of different materials. Wherein the electric conductivity of the materials of the conductive wires 55 may be higher than the conductivity of the materials of the conductive sheets 23, for example, the conductive wires 55 may be copper wires, and the conductive sheets 23 may be nickel sheets.

The above disclosure is only the preferred embodiment of the present invention, and not used for limiting the scope of the present invention. All equivalent variations and modifications on the basis of shapes, structures, features and spirits described in claims of the present invention should be included in the claims of the present invention.

1. A connection module for protecting battery cells, comprising:
a plurality of conductive sheets, wherein each of the plurality of conductive sheets is connected to a corresponding battery cell, respectively; and
a plurality of conductive wires or a conductive mesh, wherein the plurality of conductive wires or the conductive mesh is connected to the plurality of conductive sheets such that the battery cells connected with the plurality of conductive sheets are connected together via the plurality of conductive wires or the conductive mesh;
wherein an electrical conductivity of the plurality of conductive wires or the conductive mesh are higher than that of the plurality of conductive sheets.

2. The connection module according to claim 1, further comprising a eutectic portion disposed between the plurality of conductive sheets and the plurality of conductive wires, or disposed between the plurality of conductive sheets and the conductive mesh.

3. The connection module according to claim 1, wherein the battery cells connected with the plurality of conductive sheets are connected together in serial or parallel via the conductive mesh.

4. The connection module according to claim 1, wherein the conductive mesh comprises a plurality of first conductive wires arranged in a horizontal direction and a plurality of second conductive wires arranged in a vertical direction, the plurality of first conductive wires are connected to the plurality of conductive sheets, and the plurality of second conductive wires are connected to each of the plurality of first conductive wires.

5. A connection module for protecting battery cells, comprising:
a plurality of conductive connection sheets, wherein each of the plurality of conductive connection sheets is connected with two battery cells in serial, respectively; and
a plurality of conductive wires or a conductive mesh, wherein the plurality of conductive wires or the conductive mesh is connected with two of the plurality of conductive sheets such that the battery cells connected with the plurality of conductive sheets are connected together via the plurality of conductive wires or the conductive mesh in parallel; wherein an electrical conductivity of the plurality of conductive wires or the conductive mesh is higher than that of the plurality of conductive connection sheets.

6. The connection module according to claim 5, wherein the conductive mesh comprises a plurality of first conductive wires arranged in a horizontal direction and a plurality of second conductive wires arranged in a vertical direction, the plurality of first conductive wires are connected to the plurality of conductive sheets, and the plurality of second conductive wires are connected to each of the plurality of first conductive wires.

7. A connection module for protecting battery cells, comprising:
a plate body;
two connection portions, configured at two ends of the plate body, and connected with a battery cell, respectively; and
a perforation portion, wherein the perforation portion is connected between the two connection portions such that the battery cells connected with the two connection portions are connected together via the perforation portion; wherein the perforation portion comprises a plurality of strip-shaped perforations.

8. The connection module according to claim 7, wherein the perforation portion further comprises a plurality of strip-shaped conductive portions adjacent to the plurality of strip-shaped perforations.

9. A connection module for protecting battery cells, comprising:
a plurality of conductive connection sheets, wherein each of the plurality of conductive connection sheets is connected with two battery cells in serial, respectively; and
a perforation portion, wherein the perforation portion is connected to two of the plurality of conductive connection sheets such that the battery cells connected with the plurality of conductive connection sheets are connected together via the perforation portion; wherein the perforation portion comprises a plurality of strip-shaped perforations.

10. The connection module according to claim 9, wherein the perforation portion further comprises a plurality of strip-shaped conductive portions adjacent to the plurality of strip-shaped perforations.
